(19) United States
(12) Patent Application Publication
(10) Pub. No.: US 2017/0164047 A1
(43) Pub. Date: Jun. 8, 2017

(54) METHOD AND ELECTRONIC DEVICE FOR RESTRICTING VIDEO PLAYING

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Fei WANG, Beijing (CN); Wenlong BAI, Beijing (CN)

(21) Appl. No.: 15/244,893

(22) Filed: Aug. 23, 2016

Related U.S. Application Data
(63) Continuation of application No. PCT/CN2016/088936, filed on Jul. 6, 2016.

(30) Foreign Application Priority Data
Dec. 4, 2015 (CN) 201510886270.1

(51) Int. Cl. H04N 21/4408; H04N 21/454; H04N 21/254; H04N 21/414; H04N 21/45

(52) U.S. Cl. CPC H04N 21/4408; H04N 21/41407; H04N 21/4532; H04N 21/2541; H04N 21/454

(57) ABSTRACT

The present disclosure discloses a method and electronic device for restricting video playing. The method includes receiving a triggering instruction of clicking a video file; determining whether the video file is in a preset non-restricted area; directly playing the video file if the video file is in the preset non-restricted area, or outputting prompt information for decrypting the video file if the video file is not in the preset non-restricted area, according to a determination result; wherein presetting the non-restricted area includes: partitioning an area including at least one video file and encrypting the video file outside of the area. Therefore, the method and system for restricting video playing solve the problem that restrictive watching of the video file cannot be made for different watching groups during media playing.

### CROSS REFERENCE TO RELATED APPLICATIONS

The present application is a continuation of international application No. PCT/CN2016/088936 filed on Jul. 6, 2016 (attached hereto as an Appendix), and claims benefit/priority of Chinese Patent Application No. 201510886270.1, entitled “Method and Electronic Device for Restricting Video Playing” filed with the State Intellectual Property Office of China on Dec. 4, 2015, which are all incorporated herein by reference in their entirety.

### TECHNICAL FIELD

The present disclosure relates to the technical field of media communication, and more particularly, to a method and electronic device for restricting video playing.

### BACKGROUND

With the rapid development of network technology, people's demands for networks are embodied in every aspect of life, which begins to have profound influences on the society. And with the development of multimedia technology, video watching has been applied more and more widely.

Nevertheless, as types of video files are diversified, different types of video files are suitable for different watching groups. Particularly, parents are very concerned about what video files their children have watched and whether these video files are suitable for their children to watch, and the like. However, the existing multimedia platforms do not relate to these problems, nor do they have corresponding function services.

### SUMMARY

In view of this, it is an object of the present disclosure to provide a method and electronic device for restricting video playing, which solves the problem that restrictive watching of the video file may not be made for different watching groups during media playing.

In a first aspect, there is provided a method for restricting video playing according to an embodiment of the present disclosure based on the above object, which includes:

receiving a triggering instruction of clicking a video file;

determining whether the video file is in a preset non-restricted area, and directly playing the video file if it is in the preset non-restricted area, or outputting prompt information for decrypting the video file if it is not in the preset non-restricted area, according to a determination result,

wherein presetting a non-restricted area includes: partitioning an area including at least one video file and encrypting a video file outside of the area.

According to a second aspect of embodiments of the present disclosure, there is provided a non-transitory computer-readable storage medium storing executable instructions that, when executed by an electronic device, cause the electronic device to perform any one of the above methods for restricting video playing.

According to a third aspect of embodiments of the present disclosure, there is provided an electronic device including one or more processors and a memory, wherein, the memory is stored with instructions executable by the one or more processors, and the instructions are executed by the one or more processors to cause the one or more processors to perform any one of the above methods for restricting video playing.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for restricting video playing according to a first embodiment of the present disclosure;

FIG. 2 is a flowchart illustrating a method for restricting video playing according to an embodiment of the present disclosure;

FIG. 3 is a structural diagram illustrating a system for restricting video playing according to an embodiment of the present disclosure;

FIG. 4 is a schematic structure diagram of hardware of an electronic device for restricting video playing according to an embodiment of the disclosure.

### DETAILED DESCRIPTION

The exemplary embodiments will be described herein in detail, examples of which are illustrated in the drawings. In the following description in connection with the drawings, the same number in various drawings indicates the same or similar element, unless otherwise indicated. The implementations described in the following exemplary embodiments do not represent all the implementations that are consistent with the present disclosure. Rather, they are only examples of devices and methods that are consistent with some aspects of the present disclosure as detailed in the appended claims.

In order to make the objects, technical solutions and advantages of the present disclosure more clear, the present disclosure is described in further detail below in combination with the specific embodiments with reference to the drawings.

Currently, according to using status of a multimedia platform and different watching groups, the function of restrictive watching of the video file may not be realized, such that every user is able to watch all types of video files on the multimedia platform, thereby causing some concern, for example, the concern that the juveniles watch video files that are not suitable for their age. In order to solve this problem, from the perspective of user, the present disclosure appreciates that the user hopes that watching groups may be differentiated on the multimedia platform. Therefore, the idea of the present disclosure is to preset a non-restricted area on the multimedia platform to distinguish one video file from another.

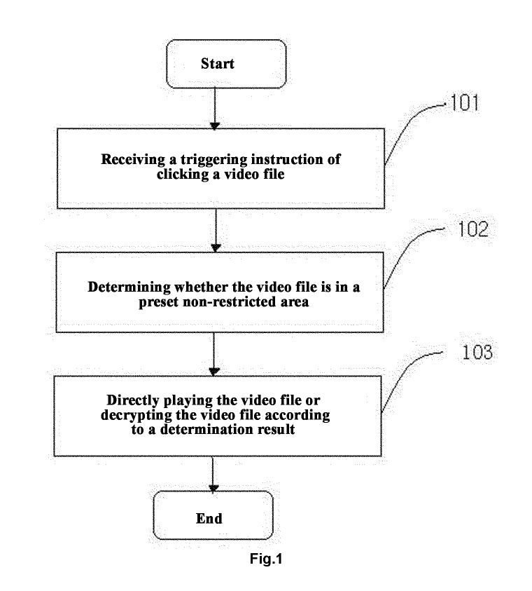

FIG. 1 is a flowchart illustrating a method for restricting video playing according to a first embodiment of the present disclosure, and the method for restricting video playing includes the following steps.

In step 101, a triggering instruction of clicking a video file is received.

In the embodiment, a user may log onto a multimedia platform and click a video file that he/she wants to watch.

In step 102, it is determined whether the video file is in a preset non-restricted area.

As an embodiment, a non-restricted area is preset. This may be performed by partitioning an area including at least one video file and encrypting a video file outside of the area. In other words, an area is partitioned, wherein the video file in the area may be watched randomly, while the video file outside of the area is restricted. The area is the non-restricted area.

A time threshold is set for total play time of the video file in the non-restricted area. When the area including at least one video file is partitioned, it is determined whether the total play time of the video file in the area exceeds a predetermined time threshold; if the total play time of the video file in the area exceeds the predetermined time threshold, the video file is removed from the area until total play time of remaining video file in the area is within the predetermined time threshold; if the total play time of the video file in the area does not exceed the predetermined time threshold, the video file in the area remains unchanged. Then, the video file outside of the area is encrypted.

After a non-restricted area is set, a video file may also be added in the non-restricted area or deleted from the non-restricted area. Specifically, the video file is added by selecting a video file outside of the non-restricted area, decrypting the video file, and dragging the video file into the non-restricted area. The video file is deleted by selecting a video file in the non-restricted area, dragging the video file out of the non-restricted area and encrypting the video file. In another embodiment, when a video file is added, it is required to determine whether total play time of a video file in the non-restricted area after adding the video file exceeds the predetermined time threshold. The specific implementation of this process has been described above. When a video file is deleted, it is dragged out of the non-restricted area and encrypted. At this point, a password for encryption is the same as that for encrypting the video file outside of the area at the time of the setting of the non-restricted area.

In another embodiment, before determining whether the video file is in the preset non-restricted area in step 102, user information is acquired, and a preset non-restricted area which matches with the user information is extracted. In other words, a watching group to which the user belongs may be known according to the user information acquired, and then a non-restricted area which matches with the watching group may be extracted for the watching group to which the user belongs. For example, it is known from the user information that the user is a juvenile, and then a non-restricted area suitable for the juvenile to watch is pushed to the user to watch the video file in the area. In other words, the multimedia platform may set non-restricted areas respectively according to different watching groups.

In addition, in a yet another embodiment, the user information on a multimedia platform may be set as family accounts. Each family account may be provided with a plurality of role accounts that are set hierarchically, and a role account with an upper hierarchy is capable of setting a non-restricted area for a role account with a lower hierarchy. For example, in a family account, the role account with the upper hierarchy is for parents, and the role account with the lower hierarchy is for children. In this manner, parents may set a non-restricted area for children on the multimedia platform. Consequently, parents may fully control the video file watched by their children. Additionally, the role account of the upper hierarchy may set the time threshold for the non-restricted area of the role account of the lower hierarchy. For example, through setting the time threshold for the non-restricted area of children, parents may control the time spent on watching video file by their children.

In step 103, according to a determination result, the video file is played directly if it is in the preset non-restricted area, or prompt information for decrypting the video file is outputted if it is not in the preset non-restricted area.

In the embodiment, it is determined whether the video file is in the preset non-restricted area, and the video file is played directly if it is in the preset non-restricted area. The video file is decrypted if it is not in the non-restricted area. The video file may be watched if it is decrypted successfully, and the video file may not be watched if it is decrypted unsuccessfully. For example, a floating layer is popped out when the video file is determined to be not in the non-restricted area, and the floating layer shows that a user needs to input a password. The password for decrypting the video file is the same as that for encrypting the video file outside of the area at the time of the setting of the non-restricted area.

It can be seen from some of the above embodiments that the method for restricting video playing described in the present disclosure restricts watching contents and time of user. Besides, the watching contents and time may also be adjusted. Moreover, the pushing of corresponding video file for different groups through a multimedia platform is realized, and meanwhile, the multimedia platform also provides a function for a user to control the video watching of another user. Therefore, the present disclosure proposes a method capable of restricting video playing in a creative manner, which may satisfy multiple demands of the user on the multimedia platform, offers the user brand-new video watching experiences, and thus greatly improves the service quality of the multimedia platform.

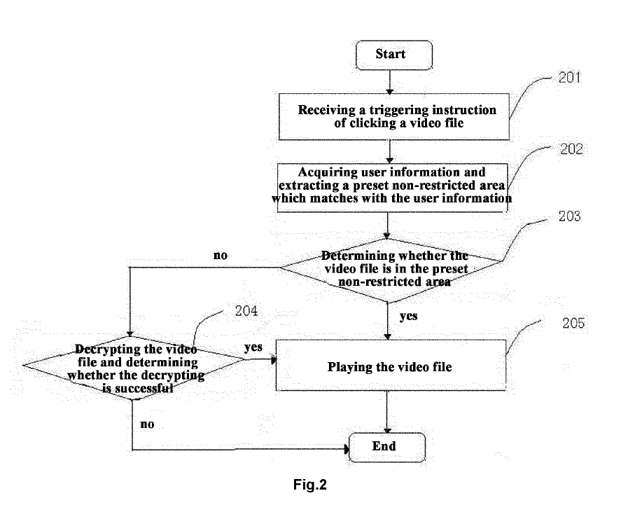

As a referable embodiment, referring to FIG. 2, the method for restricting video playing may specifically includes the following steps.

In step 201, a triggering instruction of clicking a video file is received.

In step 202, user information is acquired and a preset non-restricted area which matches with the user information is extracted.

In step 203, it is determined whether the video file is in the preset non-restricted area; if yes, the step 205 is performed directly, or if not, the step 204 is performed.

In step 204, the video file is decrypted and whether the decryption is successful is determined; if yes, the step 205 is performed, or if not, then exit; and

In step 205, the video file is directly played.

It is to be noted that the step 202 may also be to acquire a role account in the user information, and extract a non-restricted area preset for the role account by a role account with an upper hierarchy. In the step 202 executed at the moment, the user information is set as family accounts, wherein each family account includes different role accounts which are set hierarchically, and a role account with an upper hierarchy is capable of setting a non-restricted area of a role account with a lower hierarchy.

In addition, as another referable embodiment, the setting of the non-restricted area includes the following steps.

In step one, an area including at least one video file is partitioned.

In step two, it is determined whether total play time of the video file in the area exceeds a predetermined time threshold; if yes, step three is performed, or if not, step four is performed.

In step three, the video file is removed from the area until total play time of remaining video file in the area is within the predetermined time threshold, and step five is performed.

In step four, the video file in the area is retained and the step five is performed.

In step five, the video file outside the area is encrypted.

It is to be noted that a video file in a set non-restricted area may be deleted, which includes the following steps.

In step one, a video file in the non-restricted area is selected.

In step two, the video file is dragged out of the non-restricted area.

In step three, the video file is encrypted.

Furthermore, a video file may be added to the set non-restricted area, which includes the following steps.

In step one, a video file outside of the non-restricted area is selected.

In step two, the video file is decrypted.

In step three, the video file is dragged into the non-restricted area.

In step four, it is determined whether total play time of the video file in the non-restricted area at the moment exceeds the predetermined time threshold; if yes, step five is performed, or if not, step six is performed.

In step five, the video file is returned to outside the non-restricted area and the video file is encrypted.

In step six, the video file is in the non-restricted area.

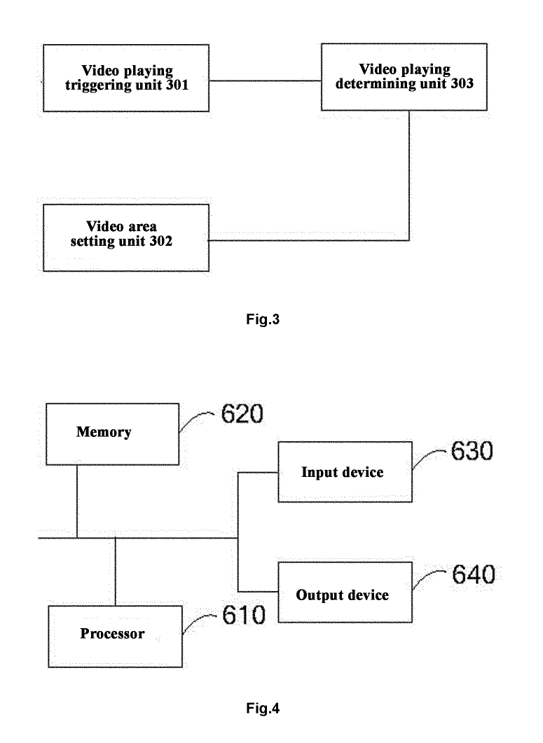

On another aspect of the disclosure, a system for restricting video playing is further provided. As shown in FIG. 3, the system includes a video playing determining unit 303 and a video playing triggering unit 301 and a video area setting unit 302 that connect with the video playing determining unit 303, respectively. The video playing triggering unit 301 is configured for receiving a triggering instruction of clicking a video file. The video area setting unit 302 is configured for presetting a non-restricted area, which includes partitioning an area including at least one video file and encrypting a video file outside of the area. The video playing determining unit 303 is configured for determining whether the video file is in the preset non-restricted area, and directly playing the video file if it is in the preset non-restricted area, or outputting prompt information for decrypting the video file if it is not in the preset non-restricted area, according to a determination result.

The video file in the non-restricted area set by the video area setting unit 302 may be randomly watched, but the video file outside of the area is restricted. A time threshold is set for the total play time of the video file in the non-restricted area. When the area including at least one video file is partitioned, whether the total play time of the video file in the area exceeds a predetermined time threshold is determined. If yes, the video file is removed from the area until total play time of remaining video file in the area is within the predetermined time threshold, or if not, the video file in the area remains unchanged. The video file outside of the area is then encrypted.

After setting a non-restricted area, the video area setting unit 302 may be further add a video file to or delete a video file from the non-restricted area. Specifically, the video file is added by selecting a video file outside of the non-restricted area, decrypting the video file, and dragging the video file into the non-restricted area. The video file is deleted by selecting a video file in the non-restricted area, dragging the video file out of the non-restricted area, and encrypting the video file. In another preferable embodiment, when a video file is added, it is required to determine whether total play time of the video file in the non-restricted area after adding the video file exceeds the predetermined time threshold, and the specific implementation of this process has already been described above. When a video file is deleted, it is dragged out of the non-restricted area and encrypted. At this point, a password for encryption is the same as that for encrypting the video file outside of the area at the time of the setting of the non-restricted area.

As another embodiment of the disclosure, the video playing determining unit 303 is configured for acquiring user information and extracting a preset non-restricted area which matches with the user information before determining whether the video file is in the preset non-restricted area. In other words, a watching group to which the user belongs may be known according to the user information acquired, and then a non-restricted area which matches with the watching group may be extracted.

As another referable embodiment, the video playing determining unit 303 may set the user information on the multimedia platform as family accounts. Each family account may be provided with a plurality of role accounts that are set hierarchically, and a role account with an upper hierarchy is capable of setting a non-restricted area of a role account with a lower hierarchy. For example, in a family account, the role account with the upper hierarchy is for parents, and the role account with the lower hierarchy is for children. In this manner, parents may set a non-restricted area for children on the multimedia platform. In addition, the role account with the upper hierarchy may set a time threshold of the non-restricted area of the role account with the lower hierarchy.

It should be also illustrated that the video playing determining unit 303 is configured for determining whether the video file is in the preset non-restricted area, and directly playing the video file if it is in the preset non-restricted area. The video file is decrypted if it is not in the non-restricted area. The video file may be watched if it is successfully decrypted; or the video file may not be watched if it is unsuccessfully decrypted. For example, a floating layer is popped out when the video file is determined to be not in the non-restricted area, and the floating layer shows that a user needs to input a password. The password for decrypting the video file is the same as that for encrypting the video file outside of the area at the time of the setting of the non-restricted area.

An embodiment of the present disclosure further provide a non-volatile computer storage medium, wherein the non-volatile computer storage medium is stored with computer executable instructions which are used to perform any of the methods for restricting video playing in the above embodiments.

FIG. 4 is a schematic structure diagram of hardware of an electronic device for restricting video playing according to another embodiment of the present disclosure. As shown in FIG. 4, the device includes one or more processors 610 and a memory 620, and FIG. 4 illustrates one processor 610 as an example.

The electronic device for restricting video playing may further include an input device 630 and an output device 640.

The processor 610, memory 620, input device 630 and output device 640 may be connected with each other through bus or other ways. FIG. 4 illustrates bus connection as an example.

As a non-volatile computer readable storage medium, the memory device 620 may be configured to store non-volatile software program, non-volatile computer executable program and module, such as program instruction/module corresponding to the method for restricting video playing according to the embodiments of the disclosure (for example, video playing triggering unit 301, video area setting unit 302 and video playing determining unit 303, as illustrated in FIG. 3). By executing the non-volatile software program, instruction and module stored in the memory 620, the processor 610 may perform various functional applications of the server and data processing, that is, achieve the method for restricting video playing according to the above mentioned embodiments.

The memory device 620 may include a program storage area and a data storage area, wherein the program storage area may store the operating system and application which are needed by at least one function, and the data storage area may store data which is created according to use of the system for restricting video playing, and the like. Further, the memory 620 may include a high-speed random access memory, and may further include a non-volatile memory, such as at least one of disk memory device, flash memory device or other types of non-volatile solid state memory device. In some embodiments, optionally, the memory 620 may include a memory provided remotely with respect to the processor 610, and such memory may be connected with the system for restricting video playing through network. The examples of the network may include but not limited to Internet, intranet, LAN (Local Area Network), mobile communication network and combinations thereof.

The input device 630 may receive inputted digital or character information, and generate key signal input related to the user settings and functional control of the device for restricting video playing. The output device 640 may include a display device such as a display screen and the like.

The above one or more modules may be stored in the memory 620. When these modules are executed by the one or more processor 610, the method for restricting video playing according to any one of the above embodiments may be performed.

The above product may perform the methods provided in the embodiments of the disclosure, and include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID, UMPC devices and the like, such as iPad;

(3) portable entertainment device, which can display and play multimedia contents, and includes audio or video player (such as iPod), portable game console, e-book and smart toys and portable vehicle navigation device;

(4) server, which is an device for providing computing service, and constituted by processor, hard disc, memory, system bus and the like, wherein the server has a framework similar to that of a computer, but is demanded for superior processing ability, stability, reliability, security, extendibility and manageability due to high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk, compact disc and the like, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for restricting video playing, which is applied to an electronic device, comprising:
receiving a triggering instruction of clicking a video file; and
determining whether the video file is in a preset non-restricted area, and according to a determination result, directly playing the video file if the video file is in the preset non-restricted area, or outputting prompt information for decrypting the video file if the video file is not in the preset non-restricted area,
wherein presetting a non-restricted area comprises: partitioning an area comprising at least one video file and encrypting a video file outside of the area.

2. The method according to claim 1, wherein, the presetting the non-restricted area further comprises:
determining whether total play time of the video file in the non-restricted area exceeds a predetermined time threshold, and if the total play time of the video file in the area exceeds the predetermined time threshold, removing the video file from the area until total play time of remaining video file in the area is within the predetermined time threshold, or if the total play time of the video file in the area does not exceed the predetermined time threshold, retaining the video file in the area.

3. The method according to claim 2, wherein, after encrypting the video file outside of the area when presetting the non-restricted area, the method further comprises:
selecting a video file in the non-restricted area; and
dragging the video file out of the non-restricted area and encrypting the video file; or
selecting a video file outside of the non-restricted area; and
decrypting the video file and dragging the video file into the non-restricted area.

4. The method according to claim 2, wherein, when receiving the triggering instruction of clicking the video file, the method further comprises:
acquiring user information, and extracting the preset non-restricted area which matches with the user information; and
determining whether the video file is in the preset non-restricted area, and directly playing the video file if the video file is in the preset non-restricted area, or decrypting the video file if the video file is not in the preset non-restricted area.

5. The method according to claim 4, wherein, the user information is set as family accounts, wherein each family account comprises different role accounts set hierarchically, and a role account with an upper hierarchy is capable of setting a non-restricted area for a role account with a lower hierarchy; when receiving the triggering instruction of clicking the video file, the method further comprises:
acquiring a role account in the user information and extracting a non-restricted area preset for the role account by a role account with the upper hierarchy; and
determining whether the video file is in the preset non-restricted area, and directly playing the video file if the video file is in the preset non-restricted area, or decrypting the video file if the video file is not in the preset non-restricted area.

6. A non-transitory computer-readable storage medium storing executable instructions that, when executed by an electronic device, cause the electronic device to:
receive a triggering instruction of clicking a video file; and
determine whether the video file is in a preset non-restricted area, and according to a determination result, directly play the video file if the video file is in the preset non-restricted area, or output prompt information for decrypting the video file if the video file is not in the preset non-restricted area,
wherein presetting a non-restricted area comprises: partitioning an area comprising at least one video file and encrypting a video file outside of the area.

7. The non-transitory computer-readable storage medium according to claim 6, wherein, when the non-restricted area is preset, the electronic device is further caused to:
determine whether total play time of the video file in the non-restricted area exceeds a predetermined time threshold, and if the total play time of the video file in the area exceeds the predetermined time threshold, remove the video file from the area until total play time of remaining video file in the area is within the predetermined time threshold, or if the total play time of the video file in the area does not exceed the predetermined time threshold, retain the video file in the area.

8. The non-transitory computer-readable storage medium according to claim 7, wherein, after the video file outside of the area is encrypted when the non-restricted area is preset, the electronic device is further caused to:
select a video file in the non-restricted area; and
drag the video file out of the non-restricted area and encrypt the video file; or
select a video file outside of the non-restricted area; and
decrypt the video file and drag the video file into the non-restricted area.

9. The non-transitory computer-readable storage medium according to claim 7, wherein, when the triggering instruction of clicking the video file is received, the electronic device is further caused to:
acquire user information, and extract the preset non-restricted area which matches with the user information; and
determine whether the video file is in the preset non-restricted area, and directly play the video file if the video file is in the preset non-restricted area, or decrypt the video file if the video file is not in the preset non-restricted area.

10. The non-transitory computer-readable storage medium according to claim 9, wherein, the user information is set as family accounts, wherein each family account comprises different role accounts set hierarchically, and a role account with an upper hierarchy is capable of setting a non-restricted area for a role account with a lower hierarchy;
the electronic device is further caused to:
when the triggering instruction of clicking the video file is received, acquire a role account in the user information and extract a non-restricted area preset for the role account by a role account with the upper hierarchy; and
determine whether the video file is in the preset non-restricted area, and directly play the video file if the video file is in the preset non-restricted area, or decrypt the video file if the video file is not in the preset non-restricted area.

11. An electronic device, comprising:
at least one processor; and
a memory communicably connected with the at least one processor,
wherein the memory is stored with instructions executable by the at least one processor, and the instructions are executed by the at least one processor to cause the at least one processor to:
receive a triggering instruction of clicking a video file; and
determine whether the video file is in a preset non-restricted area, and according to a determination result, directly play the video file if the video file is in the preset non-restricted area, or output prompt information for decrypting the video file if the video file is not in the preset non-restricted area,
wherein presetting a non-restricted area comprises: partitioning an area comprising at least one video file and encrypting a video file outside of the area.

12. The electronic device according to claim 11, wherein, when the non-restricted area is preset, the at least one processor is further caused to:
determine whether total play time of the video file in the non-restricted area exceeds a predetermined time threshold, and if the total play time of the video file in the area exceeds the predetermined time threshold, remove the video file from the area until total play time of remaining video file in the area is within the predetermined time threshold, or if the total play time of the video file in the area does not exceed the predetermined time threshold, retain the video file in the area.

13. The electronic device according to claim 12, wherein, after the video file outside of the area is encrypted when the non-restricted area is preset, the at least one processor is further caused to:
select a video file in the non-restricted area; and
drag the video file out of the non-restricted area and encrypt the video file; or
select a video file outside of the non-restricted area; and
decrypt the video file and drag the video file into the non-restricted area.

14. The electronic device according to claim 12, wherein, when the triggering instruction of clicking the video file is received, the at least one processor is further caused to:
acquire user information, and extract the preset non-restricted area which matches with the user information; and
determine whether the video file is in the preset non-restricted area, and directly play the video file if the video file is in the preset non-restricted area, or decrypt the video file if the video file is not in the preset non-restricted area.

15. The electronic device according to claim 14, wherein, the user information is set as family accounts, wherein each family account comprises different role accounts set hierarchically, and a role account with an upper hierarchy is capable of setting a non-restricted area for a role account with a lower hierarchy;
when the triggering instruction of clicking the video file is received, the at least one processor is further caused to:
acquire a role account in the user information and extract a non-restricted area preset for the role account by a role account with the upper hierarchy; and
determine whether the video file is in the preset non-restricted area, and directly play the video file if the video file is in the preset non-restricted area, or decrypt the video file if the video file is not in the preset non-restricted area.
